(19) United States
(12) Patent Application Publication
(10) Pub. No.: US 2018/0232985 A1
(43) Pub. Date: Aug. 16, 2018

(54) VENDING MACHINE

(71) Applicant: Fuji Electric Co., Ltd., Kawasaki-shi (JP)

(72) Inventors: Yoshitake YOKOTA, Yokkaichi-shi (JP); Yiguang ZHANG, Yokkaichi-shi (JP)

(21) Appl. No.: 15/876,771

(22) Filed: Jan. 22, 2018

(30) Foreign Application Priority Data
Feb. 15, 2017 (JP) 2017-026124

(51) Int. Cl. G07F 9/10; F28F 1/12

(52) U.S. Cl. CPC G07F 9/105; F25D 17/06; F28F 1/128

(57) ABSTRACT

A vending machine includes: an in-storage heat exchanger installed in an airtight heat-insulated commodity storage inside a vending machine body and configured to exchange heat between a refrigerant passing through a refrigerant flow path of the in-storage heat exchanger and inside air that is air inside the commodity storage, through a fin member; and an out-storage heat exchanger installed outside the commodity storage inside the vending machine body and configured to exchange heat between a refrigerant passing through a refrigerant flow path of the out-storage heat exchanger and outside air that is air surrounding and outside the commodity storage, through a fin member. The fin member of the in-storage heat exchanger includes louvers configured to cause the inside air passing through the airflow path to generate a meandering flow. The fin member of the out-storage heat exchanger has no louvers.

### CROSS-REFERENCE TO RELATED APPLICATION(S)

The present application claims priority to and incorporates by reference the entire contents of Japanese Patent Application No. 2017-026124 filed in Japan on Feb. 15, 2017.

### BACKGROUND

### 1. Technical Field

The disclosure relates to a vending machine.

### 2. Related Art

In the related art, vending machines selling commodities such as canned beverages and plastic bottled beverages include a body cabinet and a heat exchanger.

The body cabinet is a rectangular parallelepiped vending machine body having an opening in its front surface. The front opening is opened and closed by a door body supported by a side extending portion in the front side. This kind of body cabinet has a heat-insulated commodity storage inside thereof. The commodity storage is defined inside the body cabinet in a manner facing the front opening of the body cabinet and becomes airtight with the front opening closed by the door body.

The heat exchanger has an in-storage heat exchanger and an out-storage heat exchanger. The in-storage heat exchanger is installed inside the commodity storage. The out-storage heat exchanger is installed inside the body cabinet and outside the commodity storage, which is, installed in a machine room. The in-storage heat exchanger and the out-storage heat exchanger constitute a freezing cycle that circulates a refrigerant by being connected with a compressor and an expansion mechanism through a refrigerant tube path.

In the freezing cycle, upon driving of the compressor, the refrigerant compressed by the compressor circulates in the out-storage heat exchanger, the expansion mechanism, and the in-storage heat exchanger in this order. The out-storage heat exchanger has the refrigerant compressed by the compressor discharge heat by exchanging heat between the refrigerant and outside air passing nearby. The expansion mechanism insulates the refrigerant having discharged heat in the out-storage heat exchanger from heat and expands the refrigerant by decompressing the refrigerant. The in-storage heat exchanger exchanges heat between the refrigerant insulated from heat and expanded by the expansion mechanism and inside air in the commodity storage and evaporates the refrigerant, thereby cooling the inside air. In this manner, the above-described vending machine can cool commodities stored in the commodity storage.

Such a configuration of a heat exchanger is described that includes fin members thermally connected to refrigerant flow paths through which a refrigerant passes and louvers formed at each fin member in a cut and raised manner at predetermined intervals (see, for example, Japanese Laid-open Patent Publication No. 2005-37002).

The above-described heat exchanger can increase the contact area with air with the louvers having the air pass in a meandering manner, thereby improving the heat-exchange efficiency between the air and the refrigerant.

Use of such a heat exchanger with louvers as the in-storage heat exchanger can increase the contact area with inside air in the commodity storage and thus can improve the heat-exchange efficiency between the inside air and the refrigerant.

Use of such a heat exchanger with louvers as the out-storage heat exchanger may, however, problematically decrease the amount of air passing around the out-storage heat exchanger, because the air passing around it is taken in from outside the body cabinet, and this causes gaps between the louvers and other places clogged with dust. The decrease in the amount of air causes a reduction in the heat-exchange efficiency, which is not preferable with the machine.

### SUMMARY

It is an object of the disclosure to at least partially solve the problems in the conventional technology.

In some embodiments, a vending machine includes: an in-storage heat exchanger installed in an airtight heat-insulated commodity storage inside a vending machine body and configured to exchange, through a fin member thermally connected to a refrigerant flow path of the in-storage heat exchanger, heat between a refrigerant passing through the refrigerant flow path of the in-storage heat exchanger and inside air that is air inside the commodity storage; and an out-storage heat exchanger installed outside the commodity storage inside the vending machine body and configured to exchange, through a fin member thermally connected to a refrigerant flow path of the out-storage heat exchanger, heat between a refrigerant passing through the refrigerant flow path of the out-storage heat exchanger and outside air that is air surrounding and outside the commodity storage. The fin member of the in-storage heat exchanger includes louvers formed in a cut and raised manner at an in-storage middle wall portion forming an airflow path for the inside air, the louvers being arranged at predetermined intervals along a direction in which the inside air passes and configured to cause the inside air passing through the airflow path to generate a meandering flow. The fin member of the out-storage heat exchanger has no louvers.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a sectional side view of a vending machine of an embodiment of the disclosure;

FIG. 2 is a perspective view of a freezing cycle adapted to the vending machine illustrated in FIG. 1;

FIG. 3 is a front view of an in-storage heat exchanger illustrated in FIGS. 1 and 2;

FIG. 4 is a sectional view along A-A line in FIG. 3;

FIG. 5 is a perspective view of one of in-storage corrugated fins illustrated in FIG. 3;

FIG. 6 is an enlarged perspective view of a main portion of the in-storage corrugated fin illustrated in FIG. 5;

FIG. 7 is another enlarged perspective view of the main portion of the in-storage corrugated fin illustrated in FIG. 5;

FIG. 8 is still another enlarged perspective view of the main portion of the in-storage corrugated fin illustrated in FIG. 5;

FIG. 9 is a front view of an out-storage heat exchanger illustrated in FIGS. 1 and 2;

FIG. 10 is a sectional view along B-B line in FIG. 9;

FIG. 11 is a perspective view of one of out-storage corrugated fin illustrated in FIG. 9;

FIG. 12 is an enlarged perspective view of a main portion of the out-storage corrugated fin illustrated in FIG. 11;

FIG. 13 is another enlarged perspective view of the main portion of the out-storage corrugated fin illustrated in FIG. 11; and

FIG. 14 is a graph illustrating a change in thermal conductance with respect to the amount of air in the out-storage heat exchanger illustrated in FIG. 9 and an out-storage heat exchanger with each out-storage middle wall portion formed in a flat shape instead of a corrugated shape.

### DETAILED DESCRIPTION

Preferred embodiments of a vending machine according to the disclosure will now be described in detail with reference to the accompanying drawings.

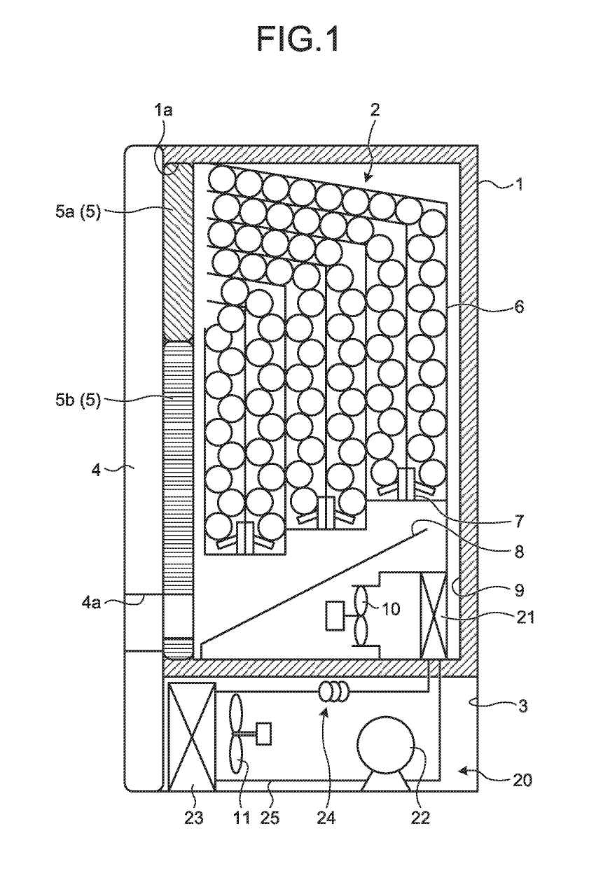

FIG. 1 is a sectional side view of a vending machine of an embodiment of the disclosure. The exemplary vending machine includes a body cabinet 1 as a body of the vending machine.

The body cabinet 1 is a rectangular parallelepiped housing with an opening (hereinafter may be referred to as a front opening) la formed on the front surface. The body cabinet 1 has a commodity storage 2, a machine room 3, an exterior door 4, an interior door 5, and a freezing cycle 20.

The commodity storage 2 is disposed in such a manner that is partitioned into right and left by a heat insulating partition board (not illustrated) and faces the front opening la in the body cabinet 1. Each commodity storage 2 accommodates commodities such as canned beverages and plastic bottled beverages while maintaining the beverages at a desired temperature and has a heat-insulated structure.

The commodity storage 2 has commodity accommodation racks 6, dispensing mechanisms 7, and a commodity shooter 8. The commodity accommodation rack 6 accommodates commodities in a manner vertically aligned. The dispensing mechanism 7 is disposed under the commodity accommodation rack 6 and dispenses commodities accommodated in the commodity accommodation rack 6 one by one from a commodity in the lowermost position. The commodity shooter 8 guides the commodity dispensed from the dispensing mechanism 7 to a commodity outlet port 4a provided to the exterior door 4.

The machine room 3 is divided from the commodity storage 2 in the body cabinet 1 and is disposed below the commodity storage 2.

The exterior door 4 is a door body large enough to cover the front opening la of the body cabinet 1 and rotatably supported by a side peripheral portion in the front side of the body cabinet 1. The exterior door 4 opens and closes the front opening la by rotating.

The interior door 5 is a heat insulating door vertically divided into two parts and covers the front surface of the commodity storage 2. In an inner position with respect to the exterior door 4, an upper door 5a is openably and closably disposed in a side peripheral portion of the exterior door 4, and a lower door 5b is openably and closably disposed in a side peripheral portion of the body cabinet 1.

With the front opening la of the body cabinet 1 closed by the exterior door 4 and the interior door 5, the commodity storage 2 becomes airtight.

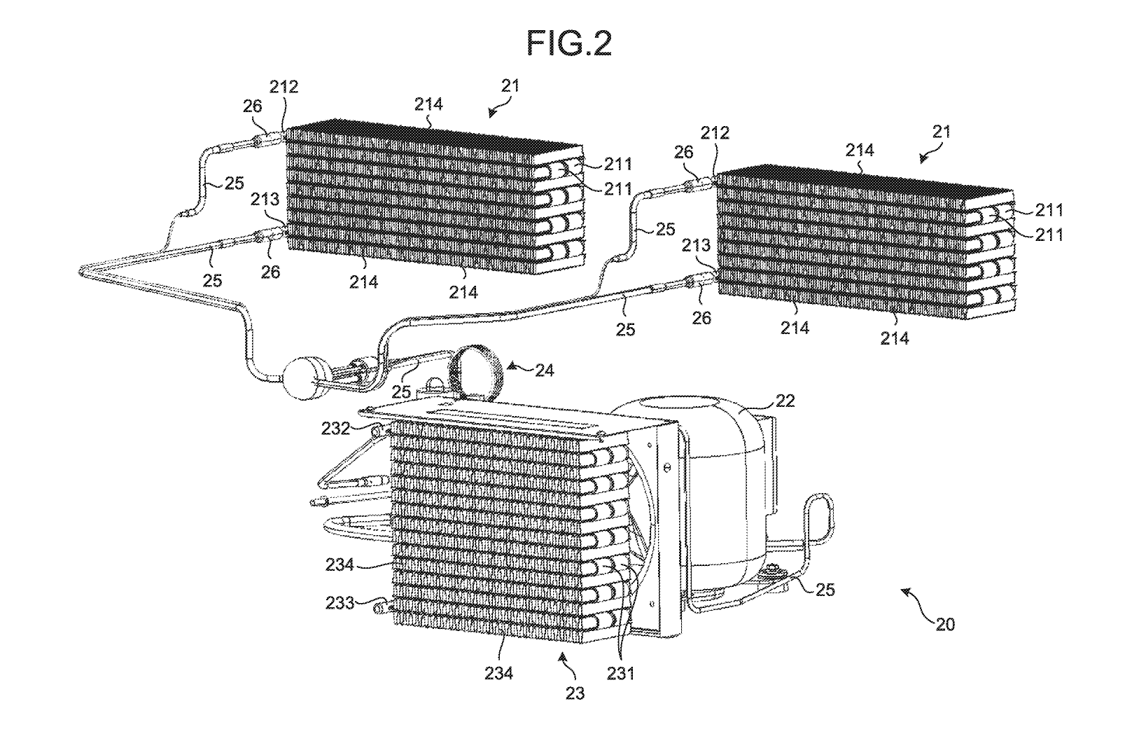

FIG. 2 is a perspective view of a freezing cycle 20 adapted to the vending machine illustrated in FIG. 1. The freezing cycle 20 is configured such that an in-storage heat exchanger 21, a compressor 22, an out-storage heat exchanger 23, and an expansion mechanism 24 are sequentially connected with one another through a refrigerant pipe 25 and has a refrigerant sealed inside thereof.

As illustrated in FIG. 1, the in-storage heat exchanger 21 is disposed below the commodity shooter 8 in the commodity storage 2 and in front of a back duct 9 disposed in the back of the commodity storage 2. The in-storage heat exchanger 21 exchanges heat between a refrigerant passing the in-storage heat exchanger 21 and inside air in the commodity storage 2. The configuration of the in-storage heat exchanger 21 will be later described.

An in-storage draft fan 10 is disposed in front of the in-storage heat exchanger 21. The in-storage draft fan 10 is a blowing means that, in a driving state, circulates inside air of the commodity storage 2 in the commodity storage 2, in other words, circulates the inside air of the commodity storage 2 such that the inside air is taken in the back duct 9, passes through the back duct 9, and subsequently passes the commodity storage 2. With this operation, the in-storage heat exchanger 21 exchanges heat between the inside air circulated by the in-storage draft fan 10, in other words, the inside air flowing around the in-storage heat exchanger 21 from back to front and a refrigerant passing the in-storage heat exchanger 21.

The compressor 22 is disposed in the machine room 3. The compressor 22 sucks a refrigerant in the in-storage heat exchanger 21 through a suck port, compresses the sucked refrigerant, and discharges from a discharge port.

The out-storage heat exchanger 23 is disposed in the machine room 3, in other words, disposed outside the commodity storage 2 in the body cabinet 1. The out-storage heat exchanger 23 exchanges heat between the refrigerant compressed by the compressor 22 and passing the out-storage heat exchanger 23 and surrounding air and has the refrigerant discharge heat. The configuration of the out-storage heat exchanger 23 will be later described.

An out-storage draft fan 11 is disposed behind the out-storage heat exchanger 23. The out-storage draft fan 11 is a blowing means that, in a driving state, sucks outside air into the machine room 3 and has the air pass around the out-storage heat exchanger 23 from front to back. With this operation, the out-storage heat exchanger 23 exchanges heat between the outside air passing around the out-storage heat exchanger 23 from front to back by means of the out-storage draft fan 11 and a refrigerant passing the out-storage heat exchanger 23.

The expansion mechanism 24 is constituted of a capillary tube and others. The expansion mechanism 24 insulates the refrigerant having discharged heat in the out-storage heat exchanger 23 from heat and expands the refrigerant by decompressing the refrigerant. The expansion mechanism 24 supplies the heat-insulated and expanded refrigerant to the in-storage heat exchanger 21.

The freezing cycle 20 circulates a refrigerant upon driving of the compressor 22. The refrigerant compressed by the compressor 22 discharges heat in the out-storage heat exchanger 23 and is concentrated. The refrigerant is insulated from heat and is expanded by the expansion mechanism 24 and thereafter passes the in-storage heat exchanger 21. When the refrigerant passes the in-storage heat exchanger 21, heat is exchanged between the inside air of the commodity storage 2 and the refrigerant. The refrigerant is evaporated and accordingly cools the inside air. The evaporated refrigerant is sucked by the compressor 22 and circulates in the freezing cycle 20.

The inside air cooled by the in-storage heat exchanger 21 circulates inside the commodity storage 2 with the in-storage draft fan 10 driving, which cools the commodities accommodated in the commodity accommodation racks 6 to a desired temperature (for example, to five degrees).

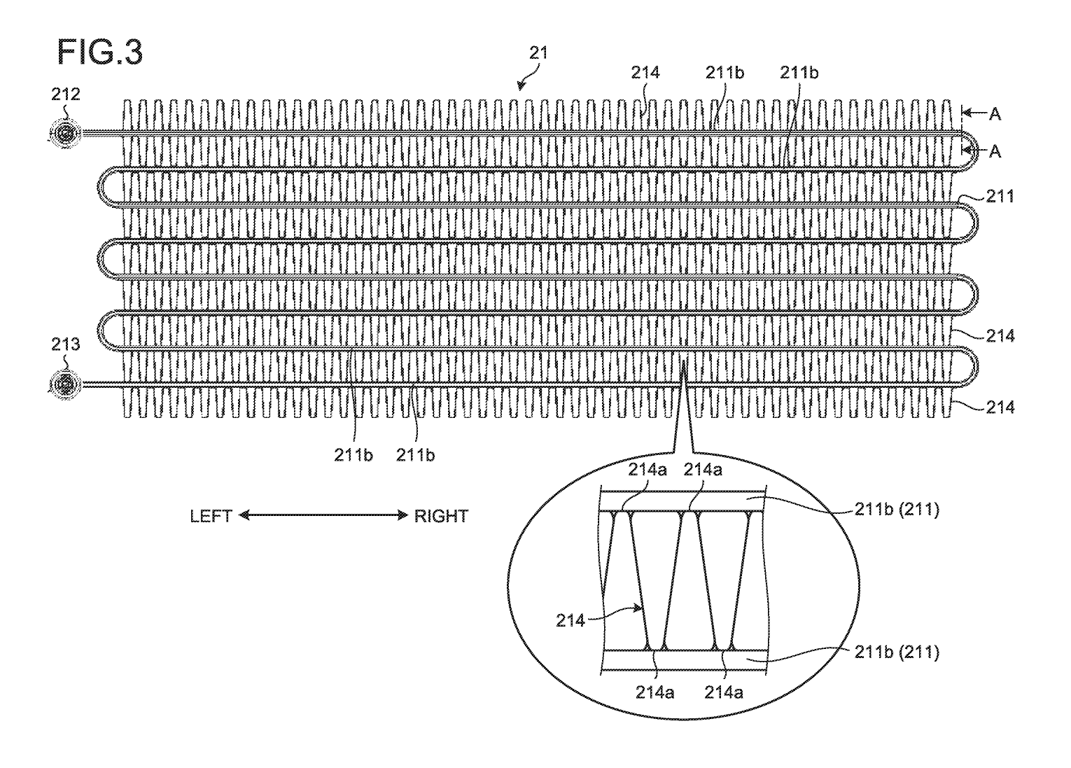

FIG. 3 is a front view of the in-storage heat exchanger 21 illustrated in FIGS. 1 and 2. The in-storage heat exchanger 21 is made from, for example, aluminum and includes in-storage refrigerant passage tubes 211, an in-storage entrance header 212, an in-storage exit header 213, and in-storage corrugated fins (fin members) 214.

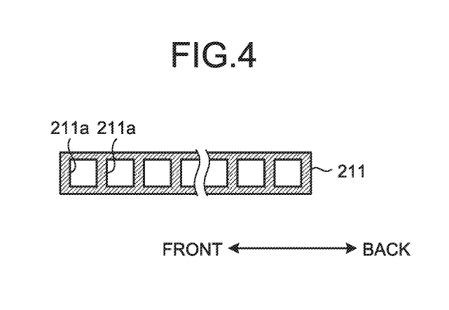

As illustrated in FIG. 4, the in-storage refrigerant passage tube 211 is a flat tube having a plurality of refrigerant paths 211a arranged side by side and is called a multi-hole tube. The in-storage refrigerant passage tube 211 is formed in a manner laterally meandering along the vertical direction.

A plurality of (two in the illustrated example) in-storage refrigerant passage tubes 211 according to the embodiment are aligned along a direction in which the inside air passes and each are laterally meandering. The in-storage refrigerant passage tube 211 constitutes a refrigerant flow path for passing the refrigerant therethrough.

The in-storage entrance header 212 is connected to an end in the entrance side of the in-storage refrigerant passage tube 211 and is provided in a manner communicating with each refrigerant path 211a of the in-storage refrigerant passage tube 211. This in-storage entrance header 212 sends a refrigerant insulated from heat and expanded by the expansion mechanism 24 and supplied through the refrigerant pipe 25 to each refrigerant path 211a. The in-storage entrance header 212 and the refrigerant pipe 25 are connected with each other by brazing with an end of the refrigerant pipe 25 disposed in the in-storage entrance header 212. A tube member 26 is tightly fixed to the connection part in a manner covering the part. The tube member 26 is made from a water-proof material and has the thermal contraction property.

The in-storage exit header 213 is connected to an end in the exit side of the in-storage refrigerant passage tube 211 and is provided in a manner communicating with each refrigerant path 211a of the in-storage refrigerant passage tube 211. The in-storage exit header 213 sends the refrigerant having passed each refrigerant path 211a, in other words, the refrigerant evaporated by undergoing a heat exchange, to the refrigerant pipe 25 connected to the compressor 22. The in-storage exit header 213 and the refrigerant pipe 25 are connected with each other by brazing with an end of the refrigerant pipe 25 disposed in the in-storage exit header 213. The tube member 26 is tightly fixed to the connection part in a manner covering the part. The tube member 26 is made from a water-proof material and has the thermal contraction property.

Each in-storage corrugated fin 214 is formed in a corrugated shape by vertically curving along a direction (the lateral direction) perpendicular to a direction (the front-to-back direction) in which the inside air passes. As illustrated in the enlarged view of FIG. 3, the in-storage corrugated fin 214 has curved exterior portions 214a joined to a horizontal extending portion of the in-storage refrigerant passage tube 211 by brazing. More specifically, the in-storage refrigerant passage tube 211 has horizontal extending portions 211b extending in parallel with one another. The in-storage corrugated fins 214 are thermally connected to the in-storage refrigerant passage tube 211 with the curved exterior portions 214a joined by brazing to the uppermost horizontal extending portion 211b, the lowermost horizontal extending portion 211b, and to the horizontal extending portion 211b in an upstream side and the horizontal extending portion 211b in a downstream side positioned next to each other.

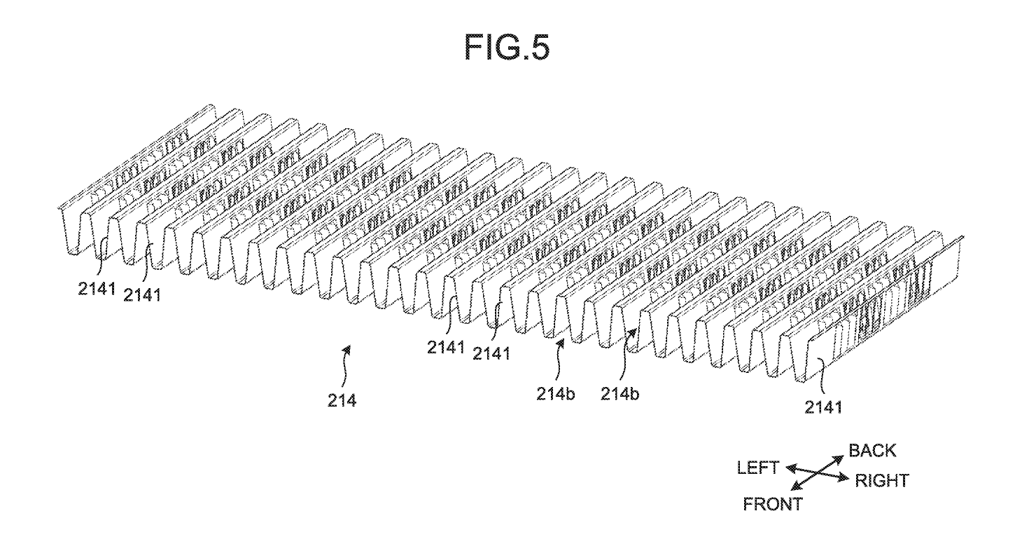

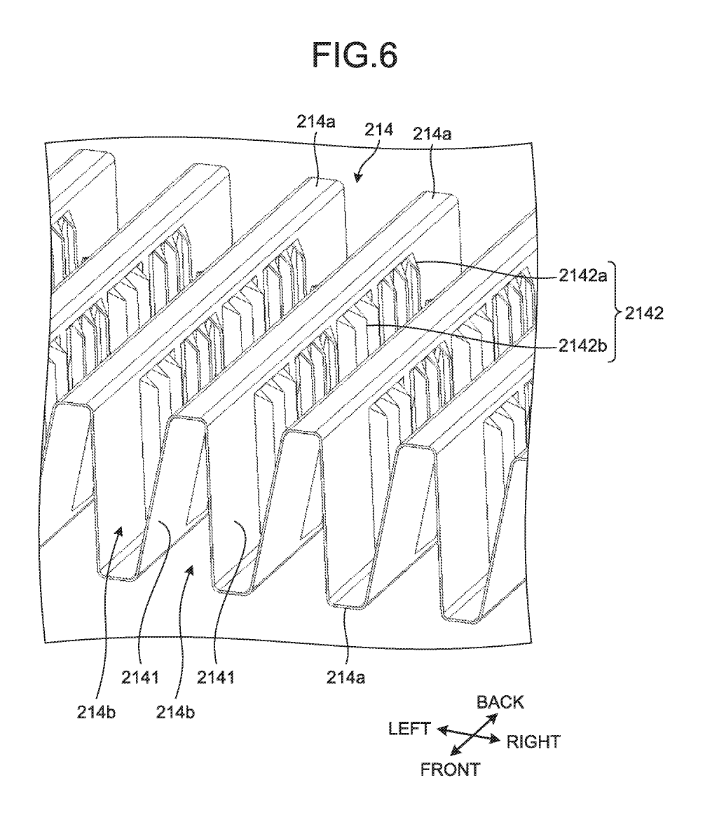

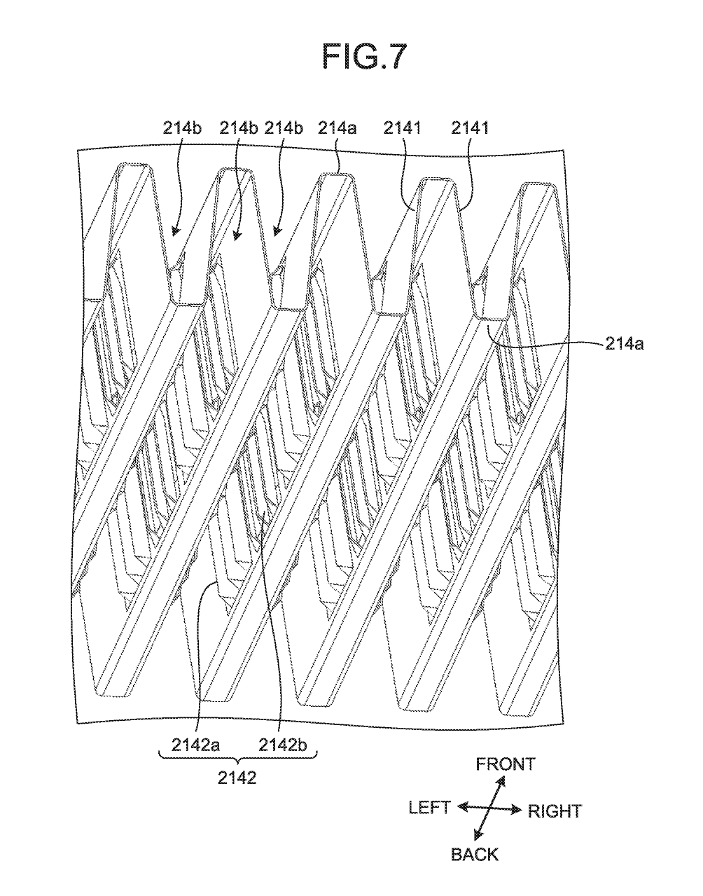

FIG. 5 is a perspective view of one of the in-storage corrugated fins 214 illustrated in FIG. 3. FIGS. 6 and 7 are enlarged perspective views of main portions of the in-storage corrugated fin 214 illustrated in FIG. 5.

As illustrated in FIG. 5 and other drawings, the in-storage corrugated fin 214 is formed in a corrugated shape by vertically curving along a direction (the lateral direction) perpendicular to a direction (the front-to-back direction) in which the inside air passes as described above and has in-storage middle wall portions 2141 each extending along the front-to-back direction.

The in-storage middle wall portion 2141 forms an airflow path 214b for the inside air. The in-storage middle wall portion 2141 is provided with louvers 2142 formed in a cut and raised manner at predetermined intervals at predetermined angles along the direction (the front-to-back direction) in which the inside air passes.

The louvers 2142 are configured such that a plurality of (three in the illustrated example) first louver portions 2142a and a plurality of (three in the illustrated example) second louver portions 2142b are alternately arranged along the front-to-back direction.

The first louver portion 2142a guides the inside air from left to right through the in-storage middle wall portion 2141. The second louver portion 2142b guides the inside air from right to left through the in-storage middle wall portion 2141.

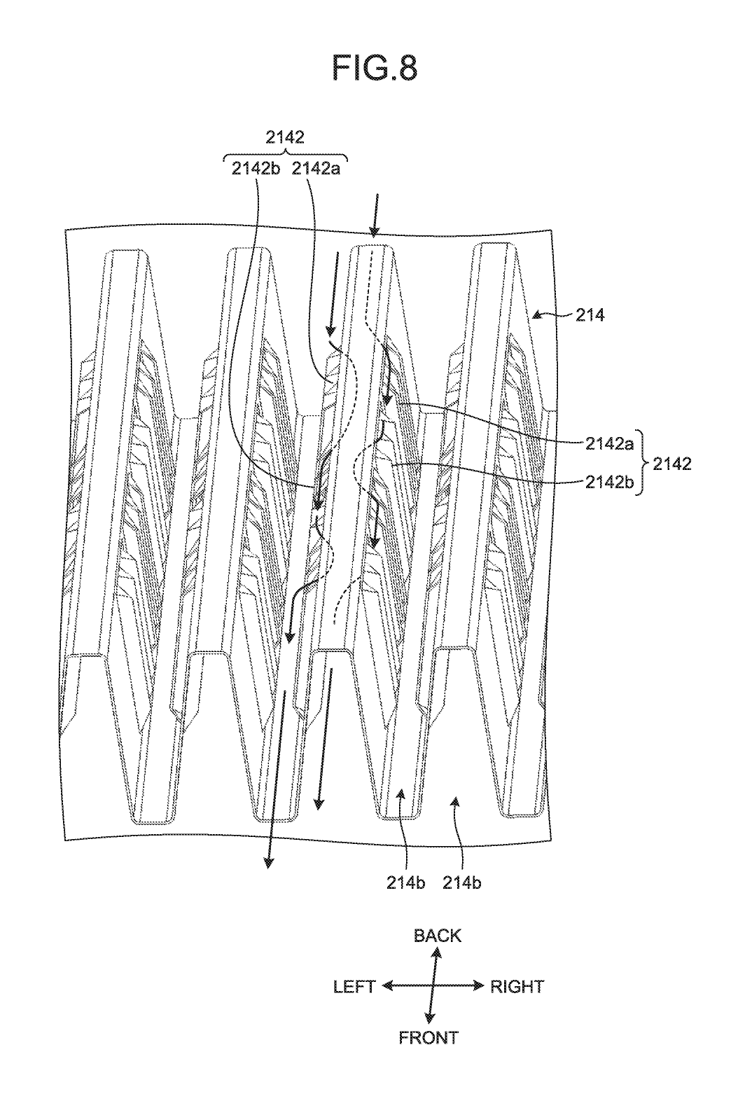

With the first louver portions 2142a guiding the inside air from left to right and with the second louver portions 2142b guiding the inside air from right to left, these louvers 2142 generates a meandering flow of the inside air when the inside air passes through the airflow path 214b as illustrated in FIG. 8.

In the in-storage heat exchanger 21 configured in this manner, the louvers 2142 formed at the in-storage middle wall portion 2141 of the in-storage corrugated fin 214 have the inside air pass in a meandering manner, which can increase the contact area with the inside air and accordingly improve the heat-exchange efficiency.

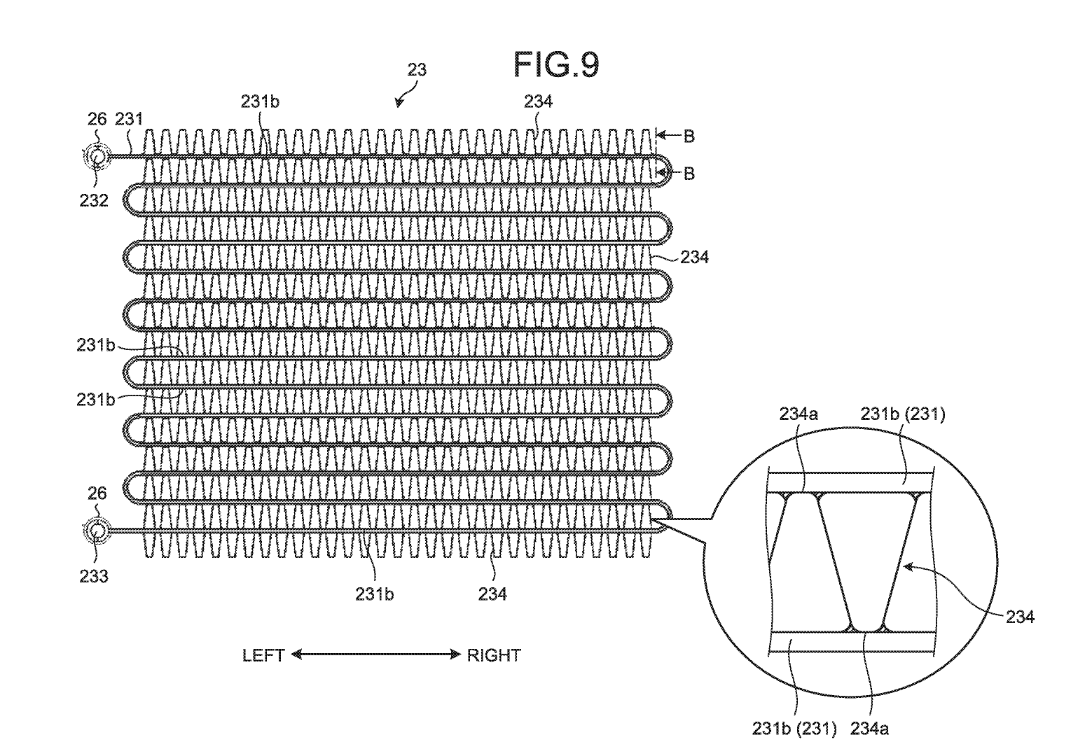

FIG. 9 is a front view of the out-storage heat exchanger 23 illustrated in FIGS. 1 and 2. The out-storage heat exchanger 23 is made from, for example, aluminum and includes out-storage refrigerant passage tubes 231, an out-storage entrance header 232, an out-storage exit header 233, and out-storage corrugated fins (fin members) 234.

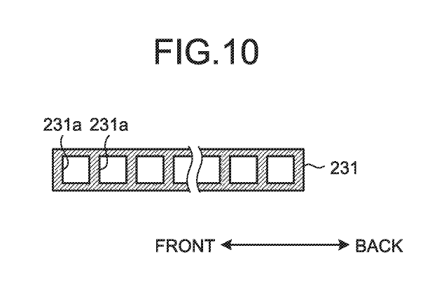

As illustrated in FIG. 10, the out-storage refrigerant passage tube 231 is a flat tube having a plurality of refrigerant paths 231a arranged side by side and is called a multi-hole tube. The out-storage refrigerant passage tube 231 is formed in a manner laterally meandering along the vertical direction.

A plurality of (two in the illustrated example) out-storage refrigerant passage tubes 231 according to the embodiment are aligned along a direction in which the outside air passes and each are laterally meandering. The out-storage refrigerant passage tube 231 constitutes a refrigerant flow path for passing the refrigerant therethrough.

The out-storage entrance header 232 is connected to an end in the entrance side of the out-storage refrigerant passage tube 231 and is provided in a manner communicating with each refrigerant path 231a of the out-storage refrigerant passage tube 231. This out-storage entrance header 232 sends a refrigerant compressed by the compressor 22 and supplied through the refrigerant pipe 25 to each refrigerant path 231a.

The out-storage entrance header 232 and the refrigerant pipe 25 are connected with each other by brazing with an end of the refrigerant pipe 25 disposed in the out-storage entrance header 232. The tube member 26 is tightly fixed to the connection part in a manner covering the part. The tube member 26 is made from a water-proof material and has the thermal contraction property.

The out-storage exit header 233 is connected to an end in the exit side of the out-storage refrigerant passage tube 231 and is provided in a manner communicating with each refrigerant path 231a of the out-storage refrigerant passage tube 231. The out-storage exit header 233 sends the refrigerant having passed the refrigerant paths 231a, in other words, the refrigerant having discharged heat by undergoing a heat exchange, to the refrigerant pipe 25 connected to the expansion mechanism 24.

The out-storage exit header 233 and the refrigerant pipe 25 are connected with each other by brazing with an end of the refrigerant pipe 25 disposed in the out-storage exit header 233. The tube member 26 is tightly fixed to the connection part in a manner covering the part. The tube member 26 is made from a water-proof material and has the thermal contraction property.

Each out-storage corrugated fin 234 is formed in a corrugated shape by vertically curving along a direction (the lateral direction) perpendicular to a direction (the front-to-back direction) in which the outside air passes. As the enlarged view of FIG. 9, each out-storage corrugated fin 234 has curved exterior portions 234a joined to a horizontal extending portion 231b of the out-storage refrigerant passage tube 231 by brazing. More specifically, the out-storage refrigerant passage tube 231 has horizontal extending portions 231b extending in parallel with one another. The out-storage corrugated fins 234 are thermally connected to the out-storage refrigerant passage tube 231 with the curved exterior portions 234a joined by brazing to the uppermost horizontal extending portion 231b, the lowermost horizontal extending portion 231b, and to the horizontal extending portion 231b in an upstream side and the horizontal extending portion in a downstream side 231b positioned next to each other.

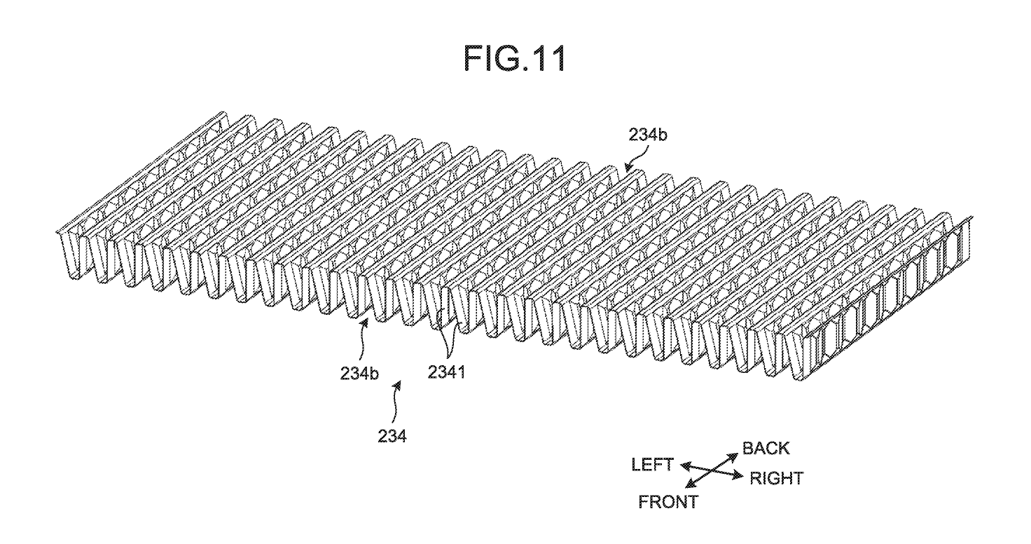

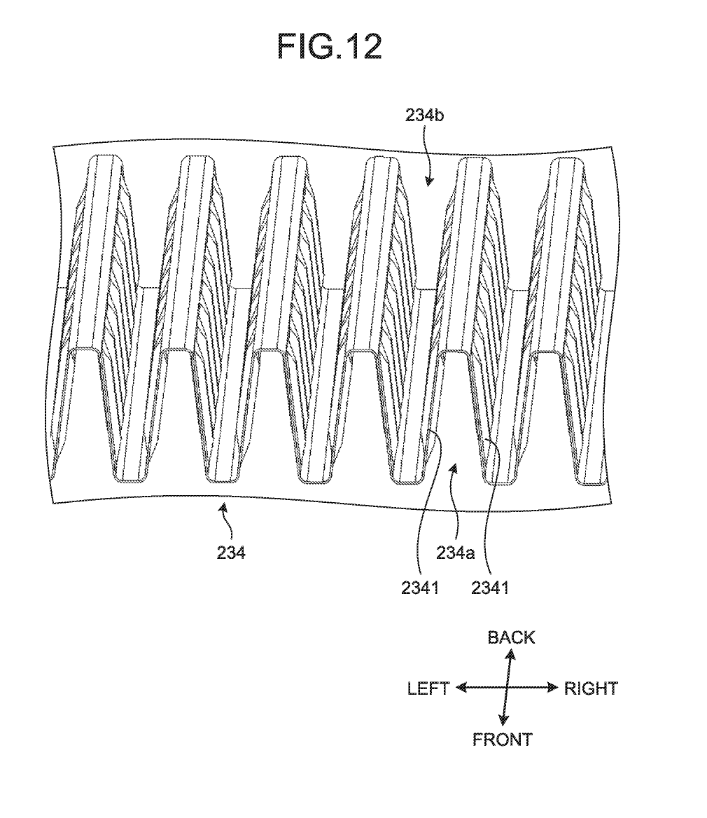

FIG. 11 is a perspective view of one of the out-storage corrugated fins 234 illustrated in FIG. 9. FIG. 12 is an enlarged perspective view of a main portion of the out-storage corrugated fin 234 illustrated in FIG. 11.

As illustrated in FIG. 11 and other drawings, the out-storage corrugated fin 234 is formed in a corrugated shape by vertically curving along a direction (the lateral direction) perpendicular to a direction (the front-to-back direction) in which the outside air passes as described above and has out-storage middle wall portions 2341 each extending along the front-to-back direction.

The out-storage middle wall portion 2341 forms an airflow path 234b for the outside air. The out-storage middle wall portion 2341 is formed in a corrugated shape by laterally curving along a direction (the front-to-back direction) in which the outside air passes.

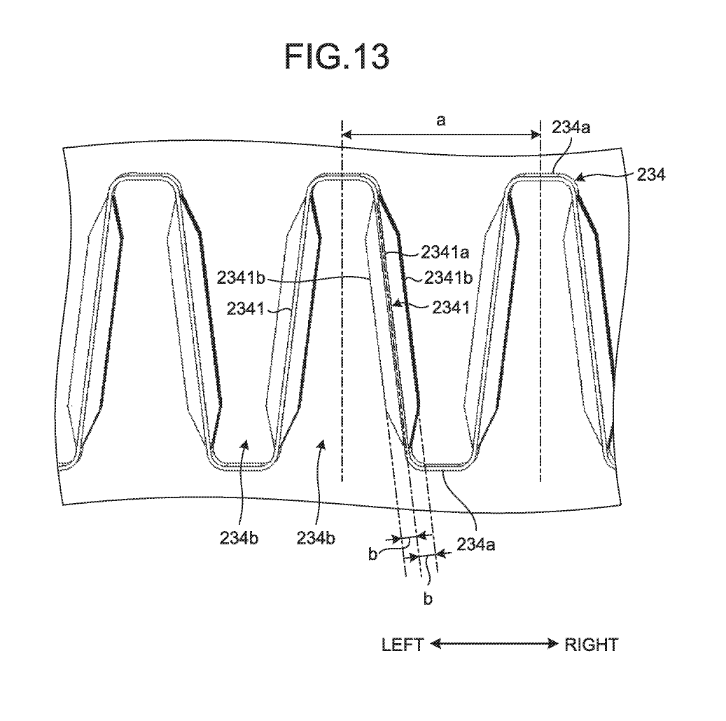

As illustrated in FIG. 13, in the out-storage corrugated fin 234, a pitch a between corrugated shapes formed along the direction (the lateral direction) perpendicular to the direction in which the outside air passes is preferably 8 millimeters, and a height b of a top 2341b of a corrugated shape of the out-storage middle wall portion 2341 is preferably 0.6 millimeters. The height b of the top 2341b of the corrugated shape of the out-storage middle wall portion 2341 is a distance from a reference plane 2341a of the out-storage middle wall portion 2341 to the top 2341b.

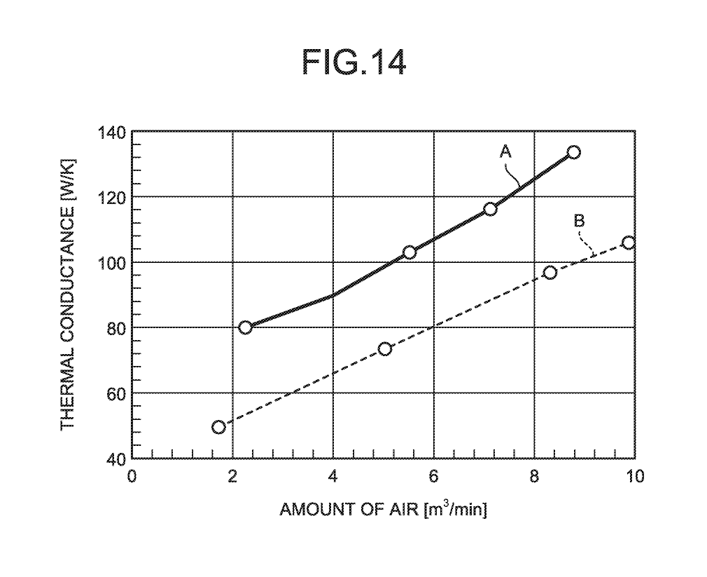

FIG. 14 is a graph illustrating a change in the thermal conductance (W/K) with respect to the amount of air (m³/min) in the out-storage heat exchanger 23 illustrated in FIG. 9 and an out-storage heat exchanger (hereinafter may be referred to as a comparative out-storage heat exchanger) having out-storage middle wall portions each formed in a flat shape instead of a corrugated shape.

The comparative out-storage heat exchanger is in substantially the same size as the out-storage heat exchanger 23 except that each out-storage middle wall portion is formed in a flat shape instead of a corrugated shape. The thermal conductance (W/K) represents the amount of heat flux per unit of area per unit of time, in other words, how easy the heat is conducted, and is calculated based on a difference in temperature between external fluid in the entrance side and external fluid in the exit side in each of the out-storage heat exchanger 23 and the comparative out-storage heat exchanger. In FIG. 14, a change in the thermal conductance with respect to the amount of air in the out-storage heat exchanger 23 is indicated as “A”, whereas the thermal conductance with respect to the amount of air in the comparative out-storage heat exchanger is indicated as “B”. As seen in FIG. 14, the out-storage heat exchanger 23 has larger thermal conductance than that of the comparative out-storage heat exchanger.

The fact that the out-storage heat exchanger 23 has larger thermal conductance than that of the comparative out-storage heat exchanger in each amount of air indicates that the out-storage heat exchanger 23 has a large amount of heat discharged from the refrigerant compared to the comparative out-storage heat exchanger.

In the out-storage heat exchanger 23 configured as above, the out-storage middle wall portion 2341 is formed in a corrugated shape, and the pitch and the height of the top 2341b are in the above-described respective sizes. This configuration is advantageous in increasing the contact area with outside air while smoothly passing the outside air, which can improve the heat-exchange efficiency between the refrigerant and the outside air.

As described above, with the vending machine according to the embodiment, the heat-exchange efficiency between the refrigerant and the inside air can be improved with the louvers 2142 for having the inside air pass in a meandering manner formed at the in-storage middle wall portion 2141 of the in-storage corrugated fin 214 in the in-storage heat exchanger 21. Furthermore, the out-storage corrugated fin 234 of the out-storage heat exchanger 23 has no louvers 2142 thereon, which prevents the louvers from being clogged with dust included in passing outside air and prevents a reduction in the amount of passing outside air. The heat-exchange efficiency of the in-storage heat exchanger 21 and the out-storage heat exchanger 23 can be therefore improved.

In the above-described vending machine, the out-storage corrugated fin 234 of the out-storage heat exchanger 23 is configured such that corrugated shapes formed along a direction perpendicular to a direction in which the outside air passes have a pitch of 8 millimeters and the top 2341b of each corrugated shape of the out-storage middle wall portion 2341 have a height of 0.6 millimeters. This configuration is advantageous in increasing the contact area with outside air while smoothly passing the outside air, which improves the heat-exchange efficiency between the refrigerant and the outside air. The heat-exchange efficiency of the in-storage heat exchanger 21 and the out-storage heat exchanger 23 thus can be further improved.

A preferred embodiment of the disclosure has been described; however, the disclosure is not limited to this embodiment and can make various changes.

In the above-described embodiment, the in-storage refrigerant passage tube 211 of the in-storage heat exchanger 21 and the out-storage refrigerant passage tube 231 of the out-storage heat exchanger 23 are made of multi-hole tubes. Instead of this structure, the disclosure can use various features for refrigerant flow paths of the in-storage heat exchanger and the out-storage heat exchanger.

According to the disclosure, a fin member in the in-storage heat exchanger has louvers that are formed in a cut and raised manner at predetermined intervals on in-storage middle wall portions forming airflow paths for the inside air along a direction in which the inside air passes and have the inside air pass in a meandering manner, which can improve efficiency in the heat-exchange with the inside air. A fin member in the out-storage heat exchanger has no louvers, which prevents louvers from being clogged with dust included in passing outside air and prevents a reduction in the amount of the passing outside air. The disclosure therefore exerts advantageous effects in improving the heat-exchange efficiency of the in-storage heat exchanger and the out-storage heat exchanger.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A vending machine comprising:
an in-storage heat exchanger installed in an airtight heat-insulated commodity storage inside a vending machine body and configured to exchange, through a fin member thermally connected to a refrigerant flow path of the in-storage heat exchanger, heat between a refrigerant passing through the refrigerant flow path of the in-storage heat exchanger and inside air that is air inside the commodity storage; and
an out-storage heat exchanger installed outside the commodity storage inside the vending machine body and configured to exchange, through a fin member thermally connected to a refrigerant flow path of the out-storage heat exchanger, heat between a refrigerant passing through the refrigerant flow path of the out-storage heat exchanger and outside air that is air surrounding and outside the commodity storage, wherein
the fin member of the in-storage heat exchanger includes louvers formed in a cut and raised manner at an in-storage middle wall portion forming an airflow path for the inside air, the louvers being arranged at predetermined intervals along a direction in which the inside air passes and configured to cause the inside air passing through the airflow path to generate a meandering flow, and
the fin member of the out-storage heat exchanger has no louvers.

2. The vending machine according to claim 1, wherein the louvers includes: a plurality of first louver portions guiding the inside air from a first side of the in-storage middle wall portion to a second side of the in-storage middle wall portion through the in-storage middle wall portion and a plurality of second louver portions guiding the inside air from the second side to the first side through the in-storage middle wall portion, the first louver portions and the second louver portions being alternately arranged along a direction in which the inside air passes.

3. The vending machine according to claim 1, wherein the fin member of the out-storage heat exchanger includes an out-storage middle wall portion forming an airflow path for the outside air, the out-storage middle wall portion being formed in a corrugated shape along a direction in which the outside air passes.

4. The vending machine according to claim 1, wherein the in-storage heat exchanger has the refrigerant flow path made from aluminum and the fin member made from aluminum.

5. The vending machine according to claim 1, wherein the out-storage heat exchanger has the refrigerant flow path made from aluminum and the fin member made from aluminum.

6. The vending machine according to claim 1, wherein each of the refrigerant flow path of the in-storage heat exchanger and the refrigerant flow path of the out-storage heat exchanger includes a multi-hole tube formed in a flat shape having a plurality of refrigerant paths arranged side by side and laterally meandering with an end connected to an entrance header and another end connected to an exit header.

7. The vending machine according to claim 6, wherein each of the fin member of the in-storage heat exchanger and the fin member of the out-storage heat exchanger is joined to a horizontal extending portion of the multi-hole tube by brazing.

8. The vending machine according to claim 7, wherein each of the fin member of the in-storage heat exchanger and the fin member of the out-storage heat exchanger is formed in a corrugated shape by vertically curving along a direction perpendicular to a direction in which air passes and includes a curved exterior portion joined to the horizontal extending portion by brazing.

9. The vending machine according to claim 8, wherein the fin member of the out-storage heat exchanger has a pitch of 8 millimeters between corrugated shapes formed along a direction perpendicular to a direction in which the outside air passes and has a height of 0.6 millimeters of a top of a corrugated shape of the out-storage middle wall portion.
